(19) United States
(12) Patent Application Publication
(10) Pub. No.: US 2008/0068718 A1
(43) Pub. Date: Mar. 20, 2008

(54) Micro-Lens Device And Method For Manufacturing The Same

(75) Inventors: Chih-Sheng Yu, Taipei County (TW); Yi-Chiuen Hu, Hsinchu County (TW); Jyh-Shih Chen, Hsinchu (TW); Heng-Tsang Hu, Kaohsiung City (TW); Hsiao-Yu Chou, Hsinchu County (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Instrument Technology Research Center, Hsinchu (TW)

(21) Appl. No.: 11/532,053

(22) Filed: Sep. 14, 2006

(51) Int. Cl. G02B 27/10

(52) U.S. Cl. 359/620

(57) ABSTRACT

A micro-lens device for manufacturing a micro-lens is provided. The micro-lens device comprises a substrate where at least a first surface area having a first surface energy, a second surface area having second surface energy and a stagnant area having a third surface energy are respectively disposed thereon. The first surface area is mounted between the first surface area and the stagnant area, and the first surface energy is lower than the second surface energy. The third surface area is highest than the first and second ones.

### FIELD OF THE INVENTION

The present invention relates to a method for manufacturing a micro-lens, and more particularly to a method for manufacturing a micro-lens device capable of calibrating the curvature thereof.

### BACKGROUND OF THE INVENTION

Micro-lenses are applicable in various fields, especially for the micro-lenses array, and play a crucial role in the optical communication, high-speed photography and display fields. Besides, a zoom micro-lens creates a tremendous application in digital cameras, displays and photo read/write heads. The mirrors or lens in traditional optical elements always rely on the additional mechanical elements, such as a gear wheel or a sliding element, to assist zooming. Such zooming mechanism not only results in a complicated structure fabricated of a huge amount of elements but produce a space-consuming device where the lifetime thereof will also be limited. In view of the above defects, the development of zooming micro-lens modules without additional assisted elements therein has been studied in recent years.

The existing common methods for manufacturing a micro-lens are introduced as follows:

Re-Flowing

A photo-resistor material being heated in the prior art is utilized to form a micro-lens by means of MEMS. A cylinder is formed by coating a photo-resistor material or a macromolecular substance on the substrate, and then the substrate is heated up to the glass transition temperature of the photo-resistor material or the macromolecular substance. During the heating, the surface of the cylinder on the substrate is melted to reflux to form a non-spherical shape due to the surface tension thereof, where a micro-lens is obtained. However, the production of the large-scaled lenses is limited due to the lower transmittance of the material and the stability of the manufacturing processes.

Another improved prior art based on the above provides a photo-resistor with two layers being heated to form a micro-lens, where the major technical scheme thereof is characterized in that the surface energies of the respective two layers of the macromolecular substance are different. During the heating, if the temperature reaches to the glass transition temperature of the macromolecular substance, the photo-resistor is softened to form a spherical shape due to the different cohesion and surface energy thereof. It is manufactured by defining a photo-resistor in the first layer and subsequently defining another photo-resistor in the second layer by means of photolithography, where the volume calculation is based on the calculation of the above single layer photo-resistor. Finally, the whole process should be heated at a higher temperature for a long period to trigger the macromolecular substance to be softened and deformed. However, such technique still bears some defects since it is manufactured at a higher temperature for a long period and the overall curvature of micro-lenses is hard to be controlled.

Hot Embossing/Pressing Model

A hot embossing/pressing model in the prior art is utilized to form a micro-lens. A nickel-mold is electroformed on a silicon substrate where the pattern thereon could be further pressed onto the macromolecular substance with a soft property. Then, the macromolecule is further molded by heating to form a micro-lens. Such a technique has superiors in a simple manufacturing procedure and a high yield; however, the curvature of the lens manufactures based thereon is hard to be controlled precisely and the manufacturing process thereof is hard to be compatible with others.

Driving Force

A liquid having a changeable surface energy with the strength of an external force to form a micro-lens is utilized in the prior art. The above technique is characterized in that an element capable of bringing an external force is fabricated into the micro-lens system, such as an electrode. By means of the arrangement of a plurality of electrodes, the fluid is driven by the changeable surface tension to be movable. The external force could be in the form of electricity, heat, and optics. While the fluid is moved to a specified position by the mentioned external forces, the curvature of the fluid will be calibrated to a desired one by means of the above relevant power sources. Furthermore, a suitable energy is given to solidify the liquid stopped on the substrate so that a micro-lens will be done. Although the liquid is movable and positioned based on the driving-force method, the movable route is still restricted to the design and layout of electrodes, where the layouts limit the planar-movable space and the ingredient of the liquid will be influenced by external power sources.

Another method for manufacturing a micro-lens by means of driving-force takes the advantage of a hydrophilicity/hydrophobicity due to a surface tension on a surface which characterizes in defining the hydrophobic area on the surface of the substrate prior to immersing the substrate under the fluid. As a result, the curvature of the lens could be controlled based on an angle, a speed and a moment to pull the substrate out of the fluid. Although such method is able to manufacture micro-lenses in a huge amount, there exist too many dynamic factors to be controlled and the overall quality of micro-lenses is hard to be consistent.

Dispensing

A dispensing technique characterizes in that an injector full of liquid injects the liquid into the substrate to form a micro-lens while an external force is applied thereon. However, if a lens is expected to be in the array form, a tri-axial control platform is required to control the precise position of the fluid.

In addition, another method for manufacturing micro-lenses by dispensing characterizes in that an angle of a globule contacting with a surface is controlled by the structure of the surface. While the fluid stops at one area of the surface, the angle of the globule contacting with the surface is changeable with the roughness of the surface. However, such method is still incapable of solving the defect of positioning the fluid without additional external forces or any auxiliary device.

Therefore, there extremely needs a micro-lens device capable of positioning and calibrating a globule to form a micro-lens and the method for manufacturing the same without additional external forces in the micro-lens filed, so as to simplify the manufacturing procedure and position precisely.

### SUMMARY OF THE INVENTION

In accordance with one aspect of the present invention, a method for manufacturing a micro-lens is provided. The method for manufacturing a micro-lens comprises the steps of (1) providing a substrate having a surface energy gradient; (2) providing a globule onto the substrate; and (3) causing the globule to form a micro-lens.

Preferably, the micro-lens is formed by one step of hardening and solidifying the globule.

Preferably, the substrate is made of one selected from a group consisting of a silicon, a glass and a macromolecular substance.

Preferably, the substrate has a surface and the surface has a hydrophobic gradient, and the surface energy gradient is resulted therefrom.

Preferably, the method for manufacturing a micro-lens further comprises a step of providing a stagnant area on the substrate.

Preferably, the globule is stopped on the stagnant area and hardened thereon.

Preferably, the stagnant area has a structural size being ranged from a micrometer dimension to a nanometer dimension.

Preferably, the stagnant area is made of a diffraction element and an optical element.

Preferably, the method for manufacturing a micro-lens further comprises a step of providing at least a first area having a first surface energy and a second area having a second surface energy, on the substrate, and the first surface energy is not the same with the second one.

Preferably, the surface energy gradient is caused by a physical property or a structural modification.

Preferably, the structural modification is performed by mounting a plurality of hollow structures at intervals on the substrate.

Preferably, the globule is made of one selected from a group consisting of water, a solvent, a chemical substance, a photo-resistor, a macromolecular substance, a UV gel and a photo-sensitive material.

Preferably, the globule is one of a ferroelectric polymer and a ferromagnetic polymer.

In accordance with another aspect of the present invention, a structure for positioning and calibrating a globule for forming a micro-lens is provided. The structure for positioning and calibrating a globule for forming a micro-lens comprises a first surface area having a first surface energy, a second surface area having a second surface energy and a stagnant area having a third surface energy. The second surface area is mounted between the first surface area and the stagnant area, and the second surface energy is higher than the first one and lower than the third one.

Preferably, a globule is further mounted on the structure and driven by the surface energy gradient to the stagnant area.

Preferably, the stagnant area is mounted on a plurality of hollow structures at intervals.

Preferably, the hollow structures at intervals receive an air therein.

In accordance with a further aspect of the present invention, a micro-lens device is provided. The micro-lens device comprises a micro-lens formed by a globule and a substrate having a surface energy gradient, wherein the globule is mounted on the substrate.

### BRIEF DESCRIPTION OF THE DRAWINGS

FIG. 1(a) is a three-dimensional diagram of the micro-lens after the globule is positioned and calibrated according to the present invention;

FIG. 1(b) is a schematic diagram of the spontaneous movement of the globule for forming the micro-lens according to the present invention;

FIG. 1(c) is a schematic diagram of the possible curvatures of the globule after positioning according to the present invention;

FIG. 2(a) is a schematic diagram showing the contacting angle between the globule and the surface having a high surface energy; and

FIG. 2(b) is a schematic diagram showing the contacting angle between the globule and the surface having a moderate surface energy;

FIG. 2(c) is a schematic diagram showing the contacting angle between the globule and the surface having a lower surface energy;

FIG. 3(a) is a structural diagram of the stagnant area according to the present invention;

FIG. 3(b) is a schematic diagram showing the globule located on the stagnant area having the structure of FIG. 3(a); and

FIGS. 4(a), 4(b), 4(c), 4(d), 4(e) and 4(f) are schematic diagrams of the forming process of the micro-lens device according to the present invention.

### DETAILED DESCRIPTION OF THE PREFERRED EMBODIMENT

The present invention will now be described more specifically with reference to the following embodiments. It is to be noted that the following discriptions of preferred embodiments of this invention are presented herein for the purposes of illustration and description only; it is not intended to be exhaustive or to be limited to the precise form disclosed.

At first, the principal of forming a micro-lens of the present invention will be illustrated as follows. While a globule is placed on a solid surface made of the consistent material, a contacting angle is generated therebetween. If the solid surface is composed of different interfaces which are probably made of materials with various properties, the contacting angle therebetween will be changed accordingly. If a globule is contacted with a hydrophobic surface, the contacting interface therebetween is defined as a composite interface below. As a result, the value of the contacting angle between the globule and the hydrophobic surface is proportional to the ratio of a real sol-gel contacting area in the composite interface to the total lower surface area of the globule. The ratio herein is represented as the name of “structural distribution density”. The smaller the structural distribution density is, the larger the contacting angle will be; whereas, the larger the structural distribution density is, the smaller the contacting angle will be. The calculation for the contacting angle of the globule in the composite interface is based on the following formula (I):

cosθ₀ =f₁ cosθ₁+f₂ cosθₛ (I)

where θ₀ represents the overall contacting angle between the globule and the hydrophobic surface in the composite interface; f₁ represents the structural distribution density of the first material in the composite interface; θ₁ represents the contacting angle between the globule and the surface of the first material in the composite interface; f₂ represents the structural distribution density of the second material in the composite interface; θ₂ represents the contacting angle between the globule and the surface of the second material in the composite interface.

Further, taking the thermodynamic equilibrium into consideration, the following formula (II) of Laplace-Young equation is applied to the contacting interface between the globule and the surrounding air.

$$Δ {P}_{S} = γ ( \frac{1}{{r}_{1}} + \frac{1}{{r}_{2}} ) \qquad ( II )$$

where r₁ and r₂ represent curvature radiuses at the respective certain points on the surface of the globule; ΔP represents the differential pressure between the points on the surface of the globule. If the globule contacts with the interface having two kinds of different hydrophobic levels, the surface heaving higher hydrophobicity is defined as a superhydrophobic surface area. The differential pressure between the superhydrophobic surface and the surrounding air is higher than that between other parts of the hydrophobic surface of the globule and the surrounding air. As a result, the globule generates a net internal pressure against the differential pressure to drive itself to move toward the smaller contacting angle. In other words, the globule tends to be movable toward the direction of the surface with less hydrophobicity.

If a static globule is desired to be movable on a solid surface, the stagnant force generated therebetween should be firstly taken against based on the following formula (III).

F=γ_{LV} ·l·(cos θ_{R}−cos θ_{A}) (III)

where l represents the characteristic length, and θ_{A} and θ_{R} respectively represent the advancing contacting angle and the receding contacting angle of the globule. It is derived from the formulas (I) and (III) that the globule is capable of being spontaneously movable while the stagnant force could be balanced with the net differential pressure, and the driving force caused by the net differential pressure should be larger than the stagnant force. As the above, the hetero-areas with different structural distribution densities on the hydrophobic surface could be generated through micro-processes, and thereby the globule on a surface is spontaneously movable toward the less hydrophobic surface area. Therefore, the moving direction of the globule could be controlled by means of modifying the characteristics of the interface between a globule and a solid surface without any external forces.

The present invention characterizes in providing the surface of the structure having a surface energy being arranged in a gradient therein, and thereby the property of the surface could assist a globule provided thereon to transport, and position. Furthermore, the curvatures of the globule are also controlled by providing such surface having a hydrophobic gradient of a structure. The present invention further provides a surface of a structure having a stagnant area mounted thereon. The stagnant area has a structural size being ranged from a micrometer dimension to a nanometer dimension, and thereby the globule provided on the surface will stop at the stagnant area and the curvature of the globule could be precisely controlled based thereon.

In view of the foregoing, the present invention provides a method for manufacturing a micro-lens. The micro-lens has a structure whose surface has a surface energy gradient for transporting and positioning the globule provided thereon and the curvature thereof could be controlled based thereon.

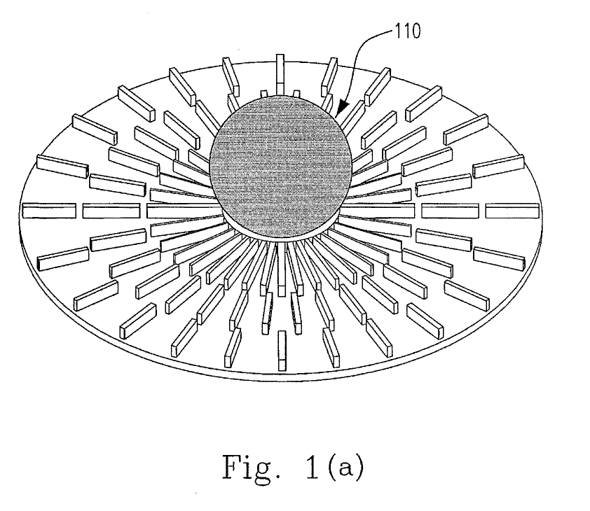

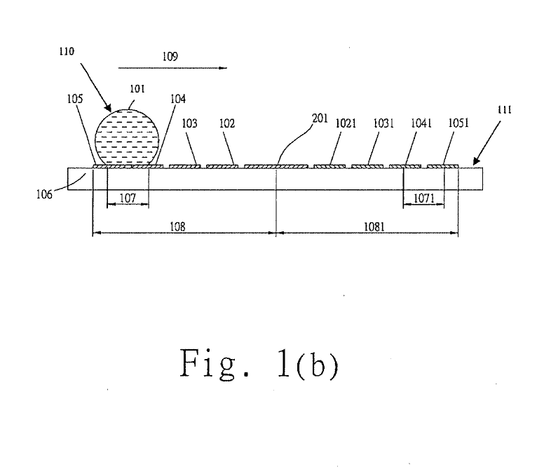

Please refer to FIG. 1(a), which shows a three-dimensional diagram of the micro-lens after the globule is positioned and calibrated according to the present invention. FIG. 1 illustrates that a globule 110 for forming the micro-lens has been positioned at a stagnant area 201 after the calibration is finished according to the method provided by the present invention.

Please refer to FIG. 1(b) together with FIG. 1(a). FIG. 1(b) shows a schematic diagram of the spontaneous movement of the globule for forming the micro-lens of the present invention. The stagnant area 201 is disposed on a substrate 106 and in a moving direction 111 of the globule 110. A surface area 102 having a first surface energy is mounted next to one side of the stagnant area 201 and a surface area 1021 having the same first surface energy is mounted corresponding to the area 102, next to another side of the stagnant area 201. A surface area 103 having a second surface energy is mounted next to the surface area 102 and a surface area 1031 having the same second surface energy is mounted corresponding to the surface area 103, next to the surface area 1021. A surface area 104 having a third surface energy is mounted next to the surface area 103 and a surface area 1041 having the same third surface energy is mounted corresponding to the surface area 104, next to the surface area 1031. A surface area 105 having a fourth surface energy is mounted next to the surface area 104 and a surface area 1051 having the same fourth surface energy is mounted corresponding to the surface area 105, next to the surface area 1041. These surface areas are respectively disposed sequentially in the center of the stagnant area 201. In conclusion, these surface areas 102, 103, 104 and 105 have the corresponding surface energies to the surface areas 1021, 1031, 1041 and 1051, and the positions of these surfaces 102, 103, 104 and 105 are also corresponding to those of the surface areas 1021, 1031, 1041 and 1051.

Please refer to FIG. 1(b) again. According to the above described principal, the globule 110 has the tendency to be movable toward the higher surface energy. If the globule 110 is desired to be movable to a pre-determined position, the stagnant area 201, the distributional variation of the surface energy on the surface of the substrate should be gradually raised from outside to inside. That is to say, the fourth surface energy of the surface area 105 should be lower than the third one of the surface area 104 which is also lower than the second one of the surface area 103. In other words, the first energy surface of the surface area 102 is higher than that of the surface areas 103, 104 and 105. As to the stagnant area 201, it has the highest surface energy as compared to the respective surface areas 102, 103, 104 and 105. As a result of the above, an unequal force is generated to drive the globule 110 to move toward a specified direction 109 while the globule 110 moves in the direction 111 of the globule 110. As illustrated in FIG. 1(b), the globule 110 tends to move toward the surface area 104 having the third surface energy while the globule is located between the surface areas 104 and 105. Finally, the globule 110 gradually moves toward the stagnant area 201 along the specified direction 109 and eventually stops at the stagnant area 201. Based on the above, the rim of the contacting interfaces between the globule 110 and the surface areas 104 and 105 define the moving boundaries 107 and 1071 of the globule 110. As a whole, if the plurality of the surface areas disposed in the moving direction 111 of the globule 110 is symmetric, the outmost surface area has the lowest surface energy, which is defined as a superhydrophobic area, and the surface center has a higher surface energy as compared to the outer surface areas. A self-calibrating area 101 of the globule 110 is defined by the boundary of the globule contacting with the surrounding air where the globule is able to vary its curvature thereduring.

Please refer to FIG. 1(c), which shows a schematic diagram of the possible curvatures of the globule after positioning according to the present invention. The globule 110 stops at the stagnant area 102 and the curvature thereof spontaneously undergoes the calibration. Then, an external energy 120 given could harden or solidify the globule 110 so as to form a micro-lens accordingly. In different kinds of conditions, the micro-lens with a desired curvature could be formed, such as a micro-lens 1101 with a first curvature, a micro-lens 1102 with a second curvature and a micro-lens 1103 with a third curvature as illustrated in FIG. 1(c). The region between the surface area 105 and the stagnant area 201 is defined as a moving region 108 of the globule 110, and correspondingly the region between the area 1051 and the stagnant area 201 is defined as a moving region 1081 of the globule 110. The external energy 120 given depends on the material property of the globule 110. Generally, the material of the globule could be one selected from a group consisting of water, a solvent, a chemical substance, a photo-resistor, a macromolecular substance, a UV gel, a ferroelectric macromolecular substance and a ferromagnetic macromolecular substance. If a photosensitive material is selected, the external energy given should be in the form of light energy to cooperate therewith.

By the way, the surface of the structure provided by the present invention is able to finish the transportation and the position of the globule 110 mounted thereon without adding any external force. The curvature of the globule 110 is capable of being self-calibrating by means of the structural design of the stagnant area 201 while stopping there at. Moreover, the surface energy gradient on the substrate 106 along the moving direction 111 of the globule 110 could be fulfilled by a photolithography, through a specified property of a material, or an interface consisting of a composite surface which generates a gradient surface energy thereon.

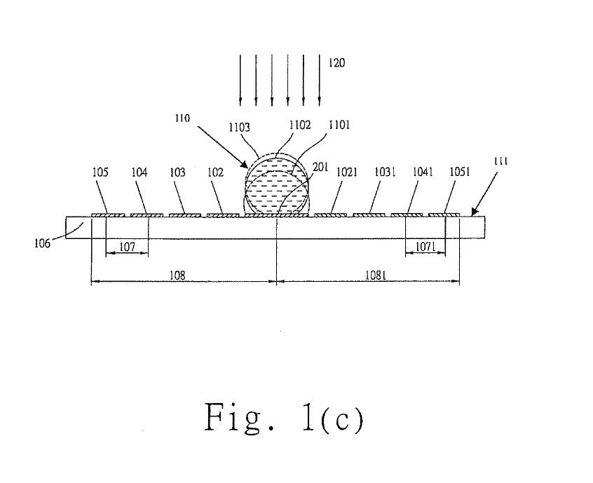

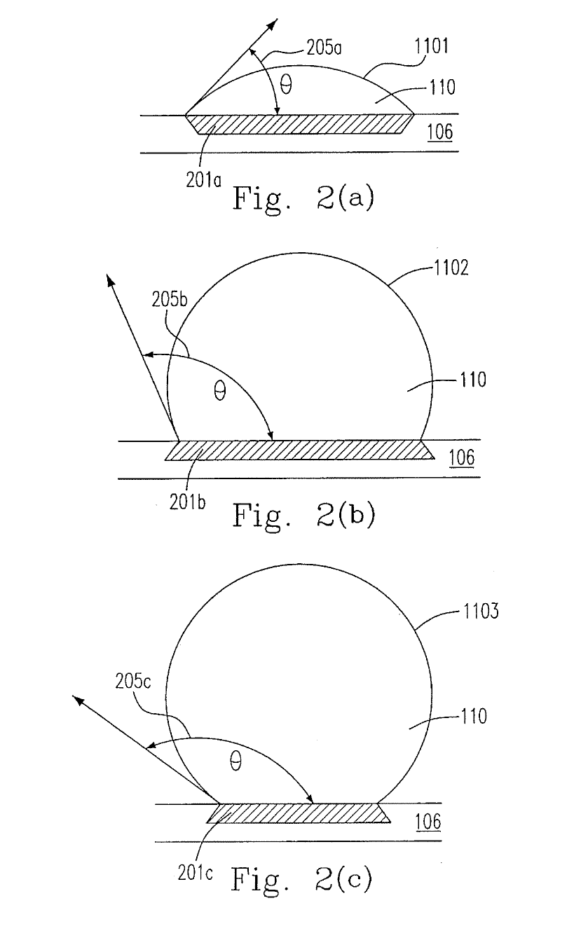

Secondly, there introduces, herein, the self-calibration of the globule for forming the micro-lens of the present invention in detail. Please refer to FIG. 2(a), which is a schematic diagram showing the contacting angle between the globule and the surface having a high surface energy. While the substrate 106 has a higher surface energy on its surface, there exists a stagnant area 201a having a higher surface energy accordingly. The contacting angle 205a between the globule 110 and the substrate 106 as illustrated is less than a right angle, whereby there bears a first curvature of the globule 110. Please refer to FIG. 2(b), which is a schematic diagram showing the contacting angle between the globule and the surface having a moderate surface energy. While the substrate 106 has a moderate surface energy, there exists a stagnant area 201b having a moderate surface energy accordingly. The contacting angle 205b between the globule 110 and the substrate 106 as illustrated is obviously larger than a right angle, whereby there bears a second curvature of the globule 110. Please refer to FIG. 2(c), which is a schematic diagram showing the contacting angle between the globule and the surface having a lower surface energy. While the substrate 106 has a lower surface energy, there exists a stagnant area 201c having a lower surface energy accordingly, that is the stagnant area 201c is relatively hydrophobic as compared with the stagnant areas 201a and 201b. The contacting angle 205c between the globule 110 and the substrate 106 as illustrated is obviously approximately 180 degree, whereby there bears a third curvature of the globule 110.

Furthermore, the optical performance of the micro-lens could be enhanced by modifying the above structure of the micro-lens. One of the modifications is to provide a micro-lens whose stagnant area has a double-side structure made of optical materials. Therefore, a micro-lens device capable of displaying a double-side optical performance is obtained while the globule 110 is solidified.

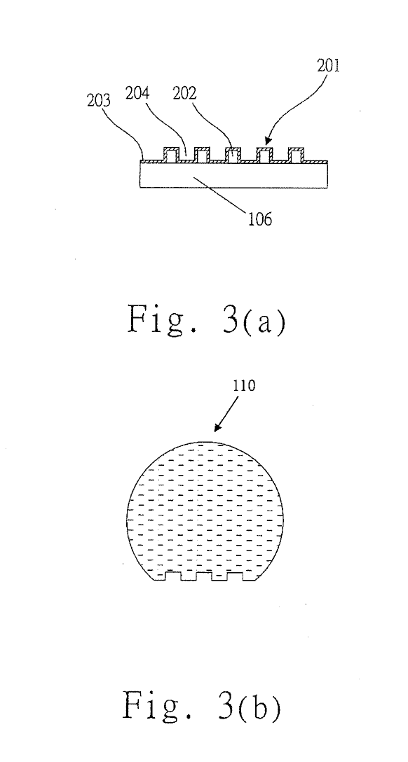

Please refer to FIG. 3(a), which shows a structural diagram of the stagnant area according to the present invention. A protruding body 202 having a structural size being ranged form a micrometer dimension to a nanometer dimension is disposed on the substrate 106. In the illustration of FIG. 3(a), the protruding bodies 202 are arranged at intervals where a plurality of hollow structures are formed thereon, and a space between the neighboring protruding bodies 202 is able to receive an air 204 therein. The stagnant area 201 is disposed on the protruding bodies 202 and on the plurality of hollow structures. The air 204 is regarded as the most hydrophobic substance whereas a stagnant area 201 becomes a surface area 203 having the lower surface energy as compared thereto. Therefore, the curvature of the globule 110 could be modified by the differential hydorphobicity between the air and the stagnant area 201. Please refer to FIG. 3(b), which shows a schematic diagram of the globule 110 located on the stagnant area 201 having the structure of FIG. 3(a). In view of such structural design of the stagnant area 202, the curvature of the globule 110 could be controlled under no external force involved therein.

If the substrate 106 is made of a transparent material, a precise position could be calibrated through the moving direction 111 of the globule 110. If the stagnant area is a plane mirror, the micro-lens will be a convex after the globule 110 is hardened, which belongs to a composite optical element having the convex together with the plane mirror.

Subsequently, the method for manufacturing the substrate for forming the micro-lens of the present invention could be achieved by the process of MEMS to reproduce a huge amount of the substrates 106. The substrate 106 could be manufactured by a hot pressing or an injecting, and the core thereof could be molded by electroforming or made of silicon chip. The huge amount of the substrates 106 could be duplicated in a short period for further manufacturing the micro-lenses of the present invention. The stagnant area of the present invention has a structural size being ranged from a nucrometer dimension to a nanometer dimension by employing a general MEMS, such as a laser processing and an electron beam processing.

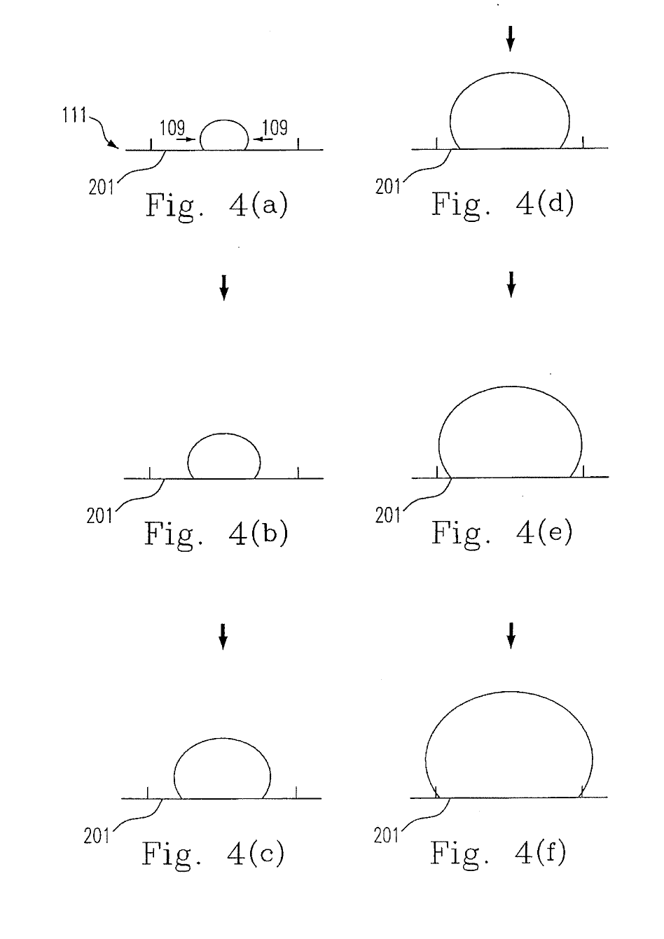

Please refer to FIG. 4, which shows a schematic diagram of the forming process of the micro-lens device provided by the present invention. According to the illustration of FIG. 4 together with that of FIG. 1(b), the globule 110 moves spontaneously toward the surface area 105 or the corresponding surface area 1051 along the direction 109 to the stagnant area 201 (referring to FIG. 4(a)), wherein the globule 110 passes by the surface area 104 and the corresponding surface area 1041 firstly, the surface area 103 and the corresponding surface area 1031 secondly and the surface area 102 and the corresponding surface area 1021 lastly. The curvature of the globule 110 could be self-calibrated due to the distributional variation of the surface energy while the globule 110 stops at the stagnant area 102, where the relevant interpretation has been described as above. Please refer to FIGS. 4(a), 4(b), 4(c), 4(d), 4(e) and 4(f). The globule 110 undergoes a deformation during the calibrating process as illustrated in FIG. 4(b). FIGS. 4(c) and 4(d) illustrate that the deformation of the globule 110 has almost completed and the transposition has been done. FIG. 4(e) illustrates that the pre-determined curvature is identified through self-calibrating repeatedly based on the structural design of the stagnant area 201 after the deformation is finished. Finally, the external energy 120 is given to solidify or harden the globule 110 so as to produce a micro-lens completely. If a plurality of globules 110 are movable along the moving direction 111 in the meantime, all are driven to move toward the stagnant area 201 by the distributional variation of the surface energy on the substrate and eventually stop at the stagnant area 201.

From the above, the self-transposition, the self-position and the self-calibration of the globule which is assisted by the surface properties of the substrate provided by the present invention are disclosed in the above. Therefore, it is apparent that the present micro-lens device and the method for manufacturing the same indeed overcome the existing defects in the micro-lens filed. A transposition, a positioning and a calibration of a globule is achieved without any external force involving therein. Moreover, the present micro-lens is applicable to the optical communication, high-speed photography, display and photo read/write heads fields.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing a micro-lens, comprising the steps of:
(1) providing a substrate having a surface energy gradient;
(2) providing a globule onto the substrate; and
(3) causing the globule to form a micro-lens.

2. The method as claimed in claim 1, wherein the micro-lens is formed by one step of hardening and solidifying the globule.

3. The method as claimed in claim 1, wherein the substrate is made of one selected from a group consisting of a silicon, a glass and a macromolecular substance.

4. The method as claimed in claim 1, wherein the substrate has a surface and the surface has a hydrophobic gradient, and the surface energy gradient is resulted therefrom.

5. The method as claimed in claim 1, further comprising a step of providing a stagnant area on the substrate.

6. The method as claimed in claim 5, wherein the globule is stopped on the stagnant area and hardened thereon.

7. The method as claimed in claim 5, wherein the stagnant area has a structural size being ranged from a micrometer dimension to a nanometer dimension.

8. The method as claimed in claim 5, wherein the stagnant area is made of a diffraction element and an optical element.

9. The method as claimed in claim 1, further comprising a step of providing at least a surface first area having a first surface energy and a second surface area having a second surface energy, on the substrate, and the first surface energy is not the same with the second one.

10. The method as claimed in claim 1, wherein the surface energy gradient is caused by a physical property or a structural modification.

11. The method as claimed in claim 10, wherein the structural modification is performed by disposing a plurality of hollow structures at intervals on the substrate.

12. The method as claimed in claim 1, wherein the globule is made of one selected from a group consisting of water, a solvent, a chemical substance, a photo-resistor, a macromolecular substance, a UV gel and a photo-sensitive material.

13. The method as claimed in claim 1, wherein the globule is one of a ferroelectric polymer and a ferromagnetic polymer.

14. A structure for positioning and calibrating a globule for forming a micro-lens, comprising:
a substrate, further comprising:
a first surface area having a first surface energy;
a second surface area having a second surface energy;
a stagnant area having a third surface energy;
wherein the surface second area is mounted between the first surface area and the stagnant area, and the second surface surface energy is higher than the first one and lower than the third one.

15. The structure as claimed in claim 14, a globule is further mounted on the substrate and driven by the surface energy gradient to the stagnant area.

16. The structure as claimed in claim 14, wherein the stagnant area is mounted on a plurality of hollow structures at intervals.

17. The structure as claimed in claim 15, wherein the hollow structures at intervals receive an air therein.

18. A micro-lens device, comprising:
a micro-lens formed by a globule; and
a substrate having a surface energy gradient, wherein the globule is mounted on the substrate.
